(19) United States
(12) Patent Application Publication
(10) Pub. No.: US 2004/0169384 A1
(43) Pub. Date: Sep. 2, 2004

(54) Litter and refuse retrieval and collection device and methods

(76) Inventor: Edward Boutwell, Noblesville, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/752,216

(22) Filed: Jan. 6, 2004

Related U.S. Application Data
(60) Provisional application No. 60/438,126, filed on Jan. 6, 2003.

(51) Int. Cl. A01K 29/00

(52) U.S. Cl. 294/1.4

(57) ABSTRACT

The present invention relates to apparatus and methods for pickup and removal of refuse by a pair of articulating jaws and placement of that refuse into a flexible bag.

This application claims the benefit of priority to U.S. provisional patent application Serial No. 60/438,126, filed Jan. 6, 2003, which is incorporated herein by reference.

### FIELD OF THE INVENTION

The present invention pertains to devices and methods used to retrieve and collect objects for later disposal, including devices and methods for retrieving and collecting litter and refuse from pets.

### SUMMARY OF THE INVENTION

One embodiment of the present invention includes a method for retrieving refuse, comprising means for retrieval at one end of a stalk, a hook along the length of the stalk, and a bag having a least one handle. The method includes placing the retrieval means in an open position. The method also includes picking up refuse by the retrieval means, and closing the retrieval means after picking up. The method further includes placing the retrieval means to the open position after moving so that the refuse is dropped into the bag.

Yet another embodiment of the present invention include a method for retrieving refuse, comprising providing a pair of articulating jaws at one end of a stalk, a hook along the length of the stalk, and a flexible bag. The method includes attaching the bag to the hook. The method also includes placing the bag such that the jaws are inside the bag. The method also includes picking up refuse and a portion of the bag into the jaws, and closing the jaws after said picking up. The method further includes articulating the jaws to the open position after said turning so that the refuse is dropped into the bag.

Yet another embodiment of the present invention includes an apparatus for picking up refuse from the ground, comprising a pair of articulating jaws at one end of a stalk. The apparatus also includes a handle at the other end of the stalk. The apparatus further includes a hook mounted to said stalk at a location between said handle and said jaws.

Yet other aspects of the present invention will be apparent from the detailed description, claims, and drawings to follow.

### BRIEF DESCRIPTION OF THE DRAWINGS

FIG. 1 is a side elevational view of an apparatus according to one embodiment of the present invention.

FIG. 2 is an end elevational view of the apparatus of FIG. 1.

FIG. 3 is a side elevational view of a portion of the apparatus of FIG. 1.

FIG. 4 is an illustration of a person using a method according to one embodiment of the present invention.

FIG. 5 is a further illustration of the method of FIG. 4.

FIG. 6 is a further illustration of the method of FIG. 4.

FIG. 7 is an illustration of a method according to another embodiment of the present invention.

FIG. 8 is a further illustration of the method of FIG. 7.

FIG. 9 is a further illustration of the method of FIG. 7.

FIG. 10 is a further illustration of the method of FIG. 7.

FIG. 11 is a further illustration of the method of FIG. 7.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

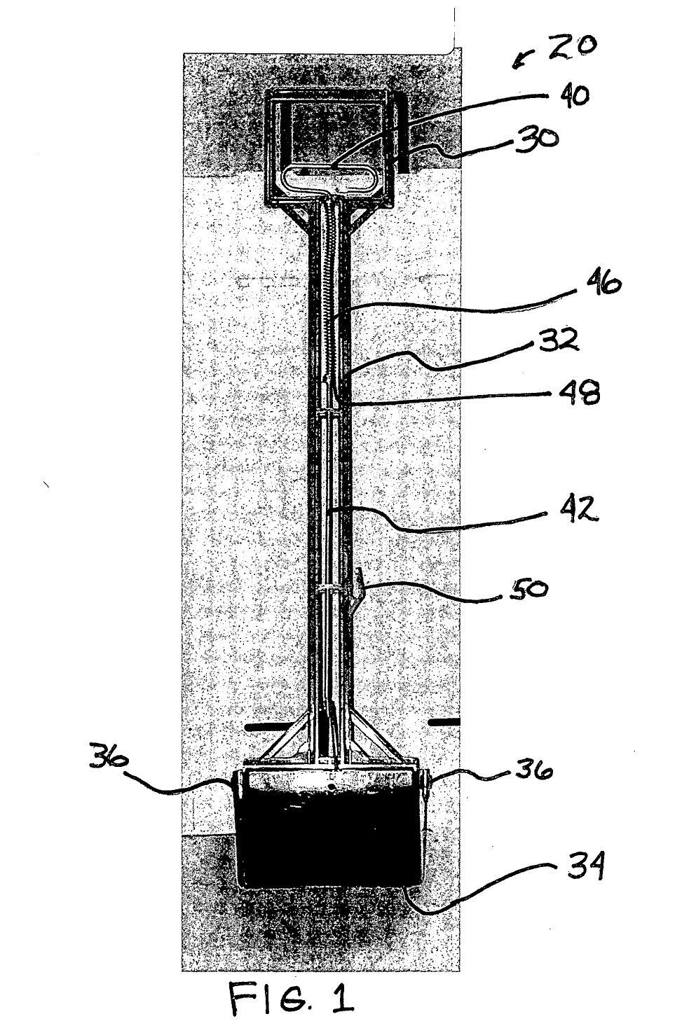

FIGS. 1, 2, and 3 depict various views of a retrieval and collection device 20 according to one embodiment of the present invention. Device 20 includes a first outer handle 30 connected by a stalk 32 to a pair of articulating jaws 34 and 35. Jaws 34 and 35 are pivotally connected to each other and to a cross member of stalk 32 by a pair of hinge pins 36.

Device 20 also includes a second, inner handle 40 located generally within handle 30. Handle 40 is connected by a central shaft 42, running generally parallel to stalk 32, to a pair of pivoting members 44 and 45 which are pivotally connected to jaws 34 and 35, respectively. A spring 46 located coaxially about shaft 42 is held in compression between a portion of handle 30 and a collar 48. Collar 48 is coupled by a setscrew to shaft 42, and can be fixedly located along shaft 42 to adjust the amount of compression in spring 46. Handles 30 and 40, shaft 42, and member 44 and 45 comprise means for articulating the jaws. However, the present invention is not so limited, and contemplates other means for articulating the jaws.

In one embodiment of the present invention, jaws 34 and 35 of device 20 are opened by a user who pulls inner handle 40 upward toward the top of outer handle 30. This upward motion of handle 40 results in an opening of jaws 34 and 35 because of the interconnection between shaft 42 and jaws 34 and 35 by pivoting members 44 and 45, respectively. If the user releases handle 40, jaws 34 and 35 are sent back to the closed position because of spring force exerted by spring 46 on collar 48.

Apparatus 20 preferably includes a hook 50 located along shaft 42 at a location proximate to the top of jaws 34 and 35. In one embodiment, hook 50 includes a plurality of downward-facing serrations 52 located along the open leg of hook 50. Preferably the open leg of hook 50 is inclined relative to stalk 32 by an angle 54. Angle 54 is about 10 degrees, although the present invention contemplates hooks with different amounts of inclination, including hooks with legs that are generally parallel to stalk 32. Further, the present invention contemplates hooks 50 which do not include serrations.

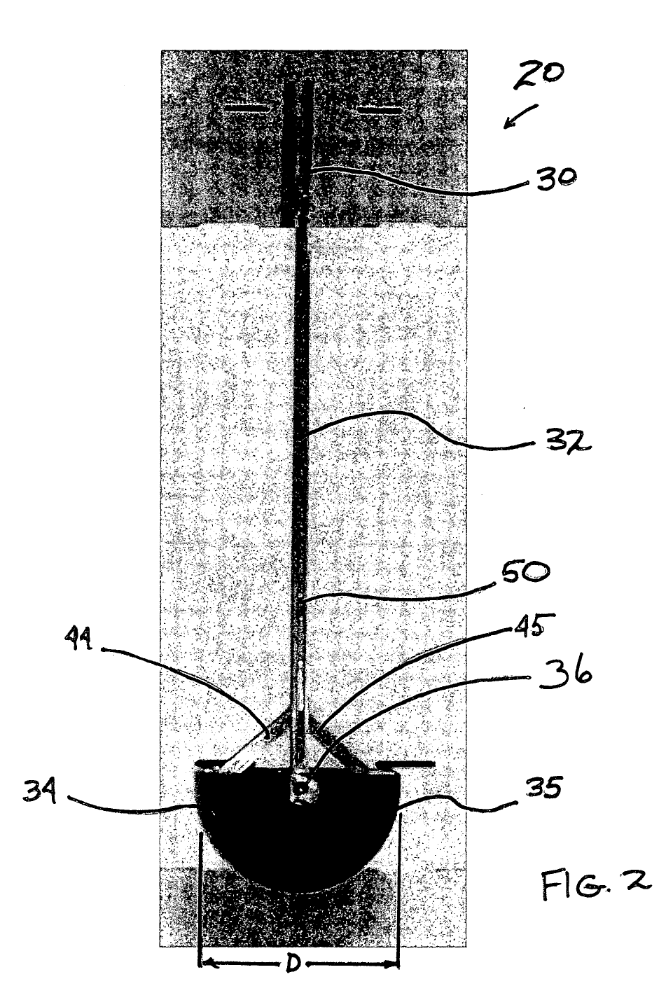

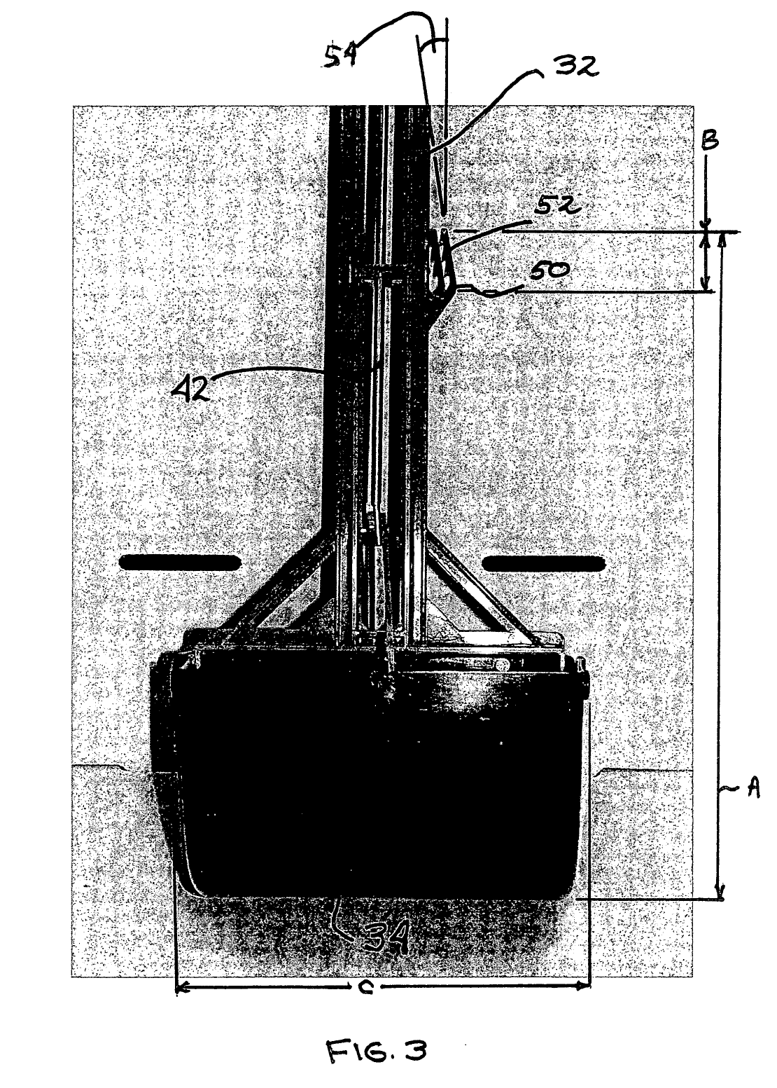

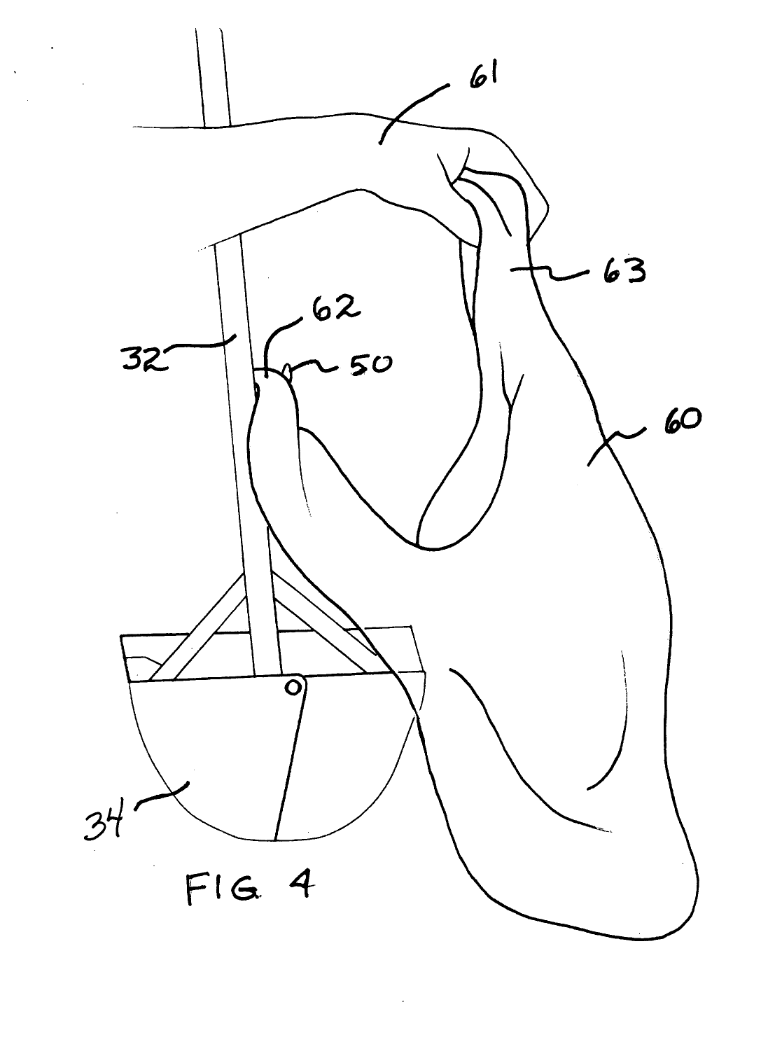

Referring to FIGS. 2, 3, and 4, hook 50 is located relative to jaws 34 and 35 to facilitate the quick, clean removal of the litter and refuse picked up by apparatus 20 into a container such as a bag 60. Referring to FIG. 3, the top of hook 50 is located from the bottom of jaws 34 and 35 by a dimension A. Further, the distance from the bottom of hook 50 to the top of hook 50 is dimension B. In a preferred embodiment, dimensions A and B are chosen so that a bag 60 fits over and around portions of device 20 in the general manner depicted in FIGS. 4-11.

By appropriate selection of dimensions A and B, device can be used with plastic bags of generally standard sizes that are widely available. As will be discussed, the bag 60 should also be sufficiently wide to pass over jaws 34 and 35 having a width D and length C (as best seen in FIGS. 2 and 3). In one embodiment, for jaws having dimensions C and D of about 6 and ¼ inches and 6 and ¾ inches, respectively. Dimension A is about 11 inches and dimension B is about 1 inch.

In a preferred embodiment, bag 60 is a thin-wall plastic bag such as a T-shirt or punch handle bag commonly used for retail sales. As examples, in a preferred embodiment dimensions A and B are selected for use with T-shirt bags sold by Anchor Bag of Houston, Tex. T-shirt bags as offered for sale at www.aplasticbag.com; and T-shirt bags and punch handle bags as offered for sale at www.zippack.com.

In some embodiments, the T-shirt bags have an opening of approximately 8 inches by 4 inches, and a length of 16 to 18 inches. In yet other embodiments, the placement of the hook is sized for bags that have openings of about 10 inches by 5 to 6 inches, and lengths of 18 to 23 inches. In still other embodiments, a punch handle bag having an opening width of about 9 inches and a length of about 11 inches is contemplated. In yet other embodiments, a punch handle bag having an opening width of about 11 inches and a length of about 14 inches is contemplated.

Although specific dimensions A, B, C, and D have been disclosed, the present invention is not limited to these approximate dimensions. For example, some embodiments of the present invention contemplate the use of thin-wall plastic bags having custom dimensions. In those embodiments, the dimensions A, B, C, and D are selected such that the size of the bag opening and the depth of the bag permit use of the bag as generally shown in FIGS. 4-11. In addition, although the use of thin-wall plastic bags has been shown and described, the present invention also contemplates the use of paper bags, and other flexible containers.

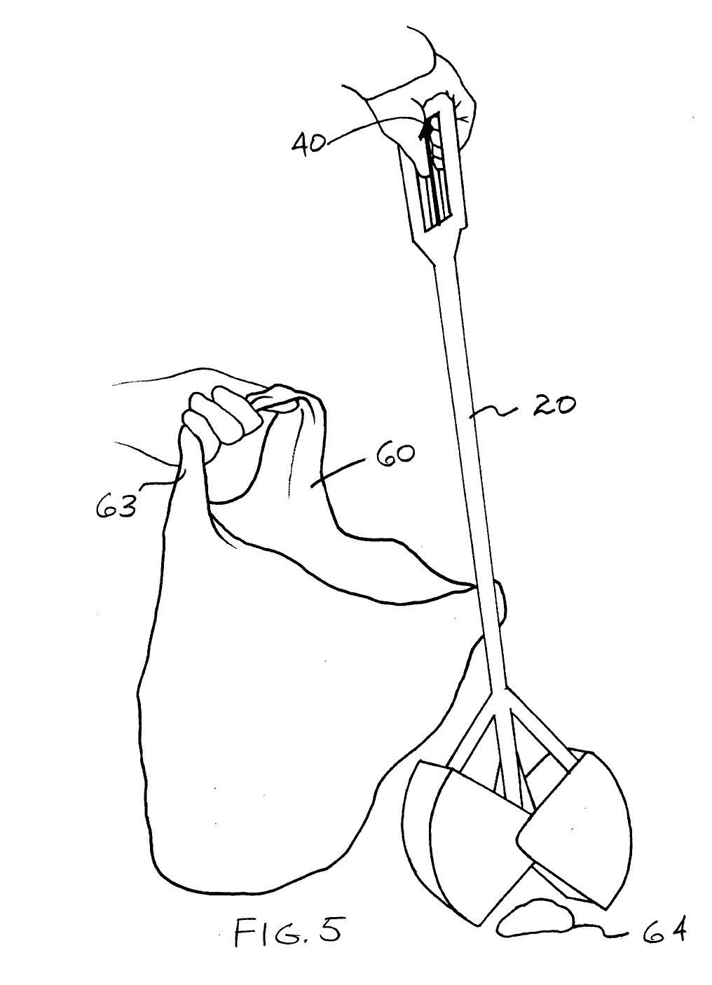

FIGS. 4-6 depict the use of a bag 60 with a device 20 according to one method of the present invention. Referring to FIG. 4, a user 61 attaches one handle or loop 62 of a bag 60 onto hook 50. The other handle or loop 63 is held by the user. As shown in FIG. 5, the user then opens jaws 34 and 35 by pulling upward on handle 40. The open jaws of device 20 are then placed in contact with the ground on either side of a quantity of refuse 64, after which the user releases handle 40 to pick up the refuse 64 by the open edges of jaws 34 and 35 for containment within the now-closed jaws.

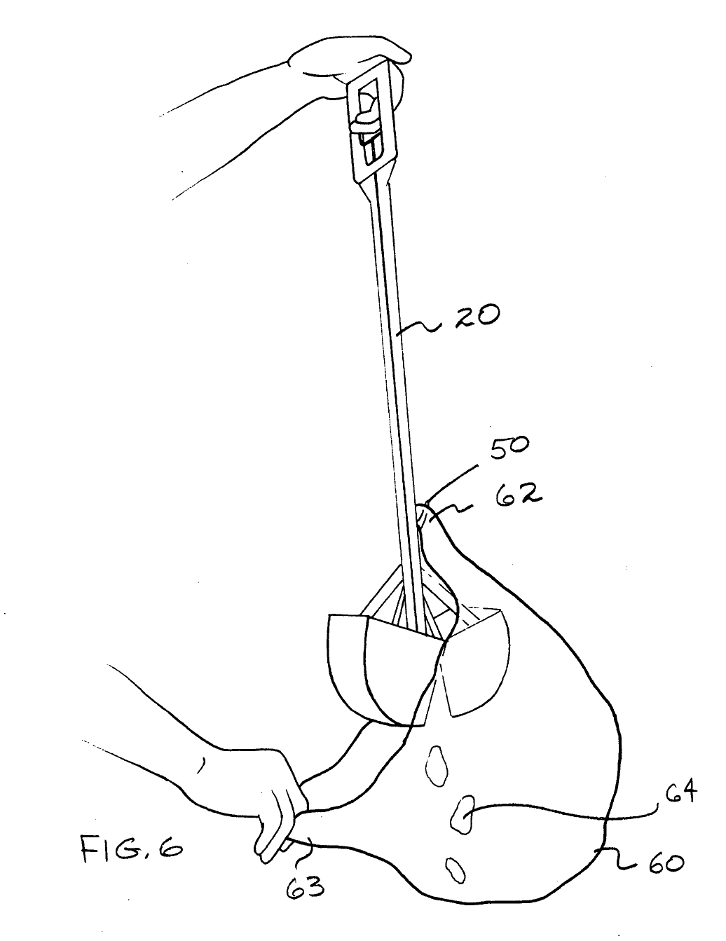

Referring to FIG. 6, the user then brings around handle 63 such that the distal portion of the jaws 34 and 35 are within the opening of bag 60 and located at least partially within the interior of bag 60. As one example, the handle 63 held by the user can be moved toward and under device 20 and brought to the side of device 20 opposite of hook 50, such as by turning bag 60 inside out. With at least the bottom opening of jaws 34 and 35 being located within the interior of bag 60, the user can pull up on handle 40, spreading apart the jaws, and thereby dropping the refuse 64 to within the interior of bag 60. The user then removes handle 62 from hook 50 and disposes of the bag and refuse.

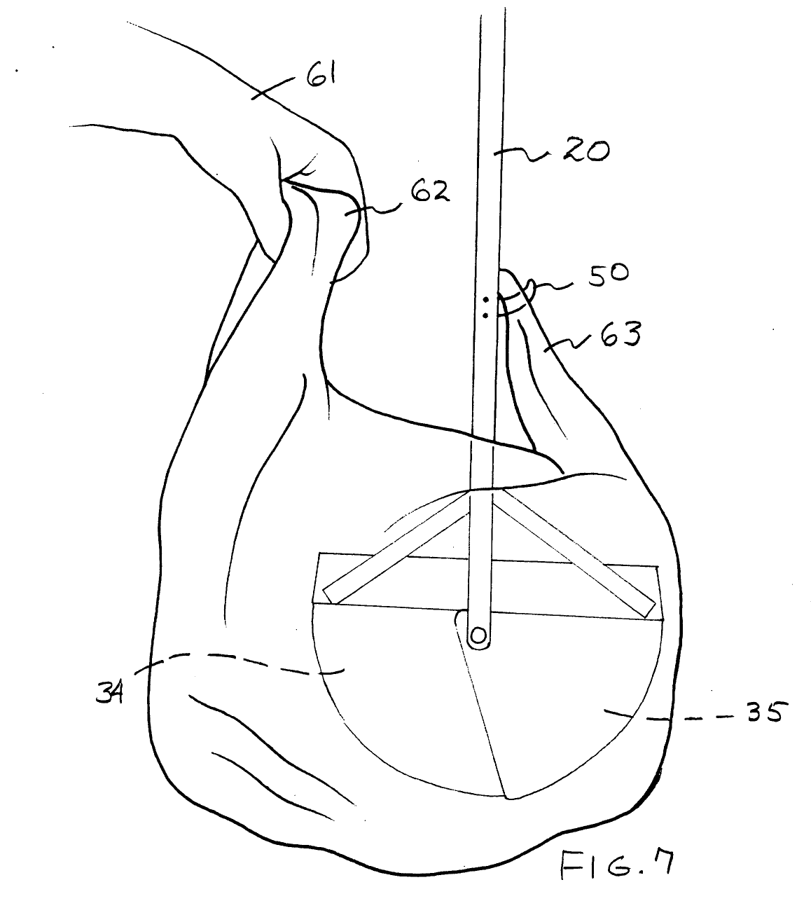

FIGS. 7-11 depict acts according to another method of the present invention using an apparatus according to one embodiment of the present invention. Referring to FIG. 7, a user 61 places a handle 63 of a bag 60 onto hook 50 of device 20. The user moves bag 60 over and around jaws 34 and 35, such that jaws 34 and 35 are located within the interior of bag 60. The user can hold the other handle 62 at a location roughly equivalent to the hooked attachment of handle 63. Alternatively, the user 61 can place handle 62 onto hook 50, such that hook 50 holds onto both handles 62 and 63. The empty jaws 34 and 35 of device 20 are preferably located entirely within the interior of bag 60.

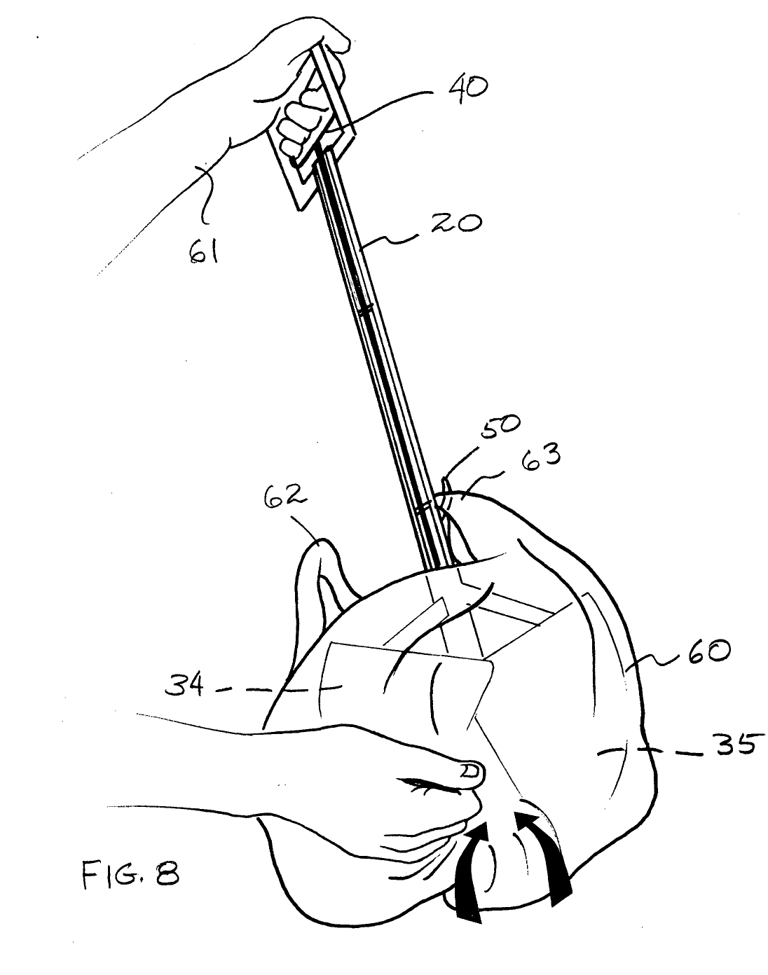

Referring to FIG. 8, the user opens and separates jaws 34 and 35 by pulling on handle 40. The user then tucks bag 60 within the interior of the open jaws. In some embodiments of the present invention, the act of manually tucking the bag within the interior of the jaws can be skipped.

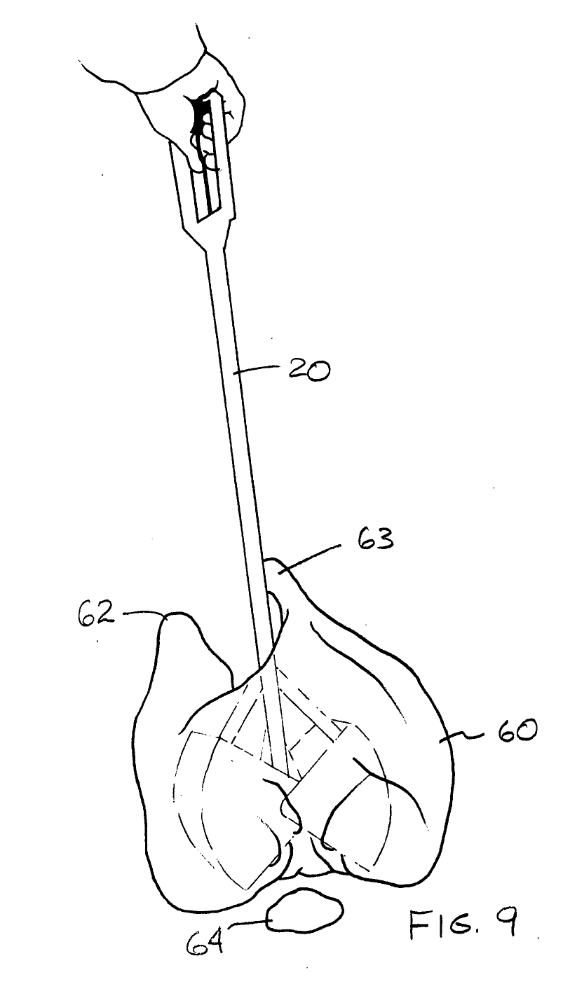

Referring to FIG. 9, the user places device 20, with jaws 34 and 35 open, over the litter or refuse 64 to be picked up. A portion of bag 60 is thereby placed on top of the refuse 64. The user then releases handle 40, such that jaws 34 and 35 return to their spring-loaded, closed position. The closing action of jaws 34 and 35 trap both the refuse and a portion of bag 60 within the interior of the jaws. When closed, refuse 64 is contained within a portion of bag 60, and that portion of bag 60 is contained within the closed jaws 34 and 35.

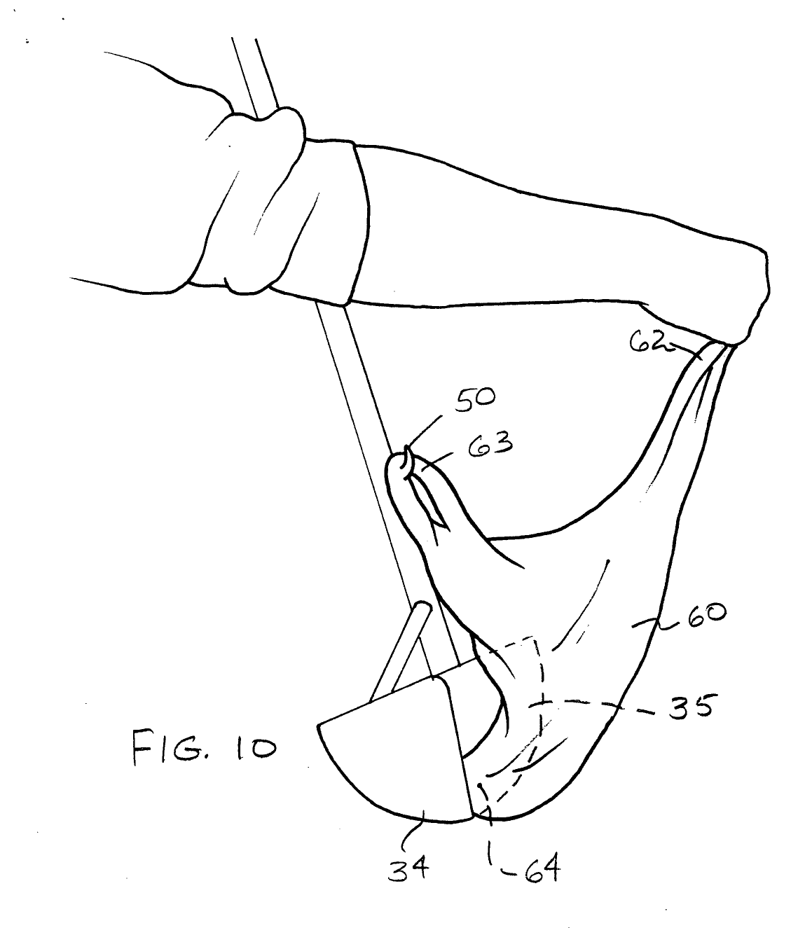

Referring to FIG. 10, with jaws 34 and 35 still closed and refuse 64 located therein, the user then unhooks handle 63 from hook 50 (and also handle 62 if handle 62 was previously attached to hook 50), brings handle 63 around the closed jaws and into contact with handle 62, and turns device 20 at least partly upside-down, such that refuse 64 is lower than the opening interface between jaws 34 and 35. Alternatively, the handles 62 and 63 of bag 60 are positioned such that they are above the top surface of jaws 34 and 35. In either case, bag 60 has been turned inside-out because of the action of unhooking handle 63 and bringing it around the closed jaws.

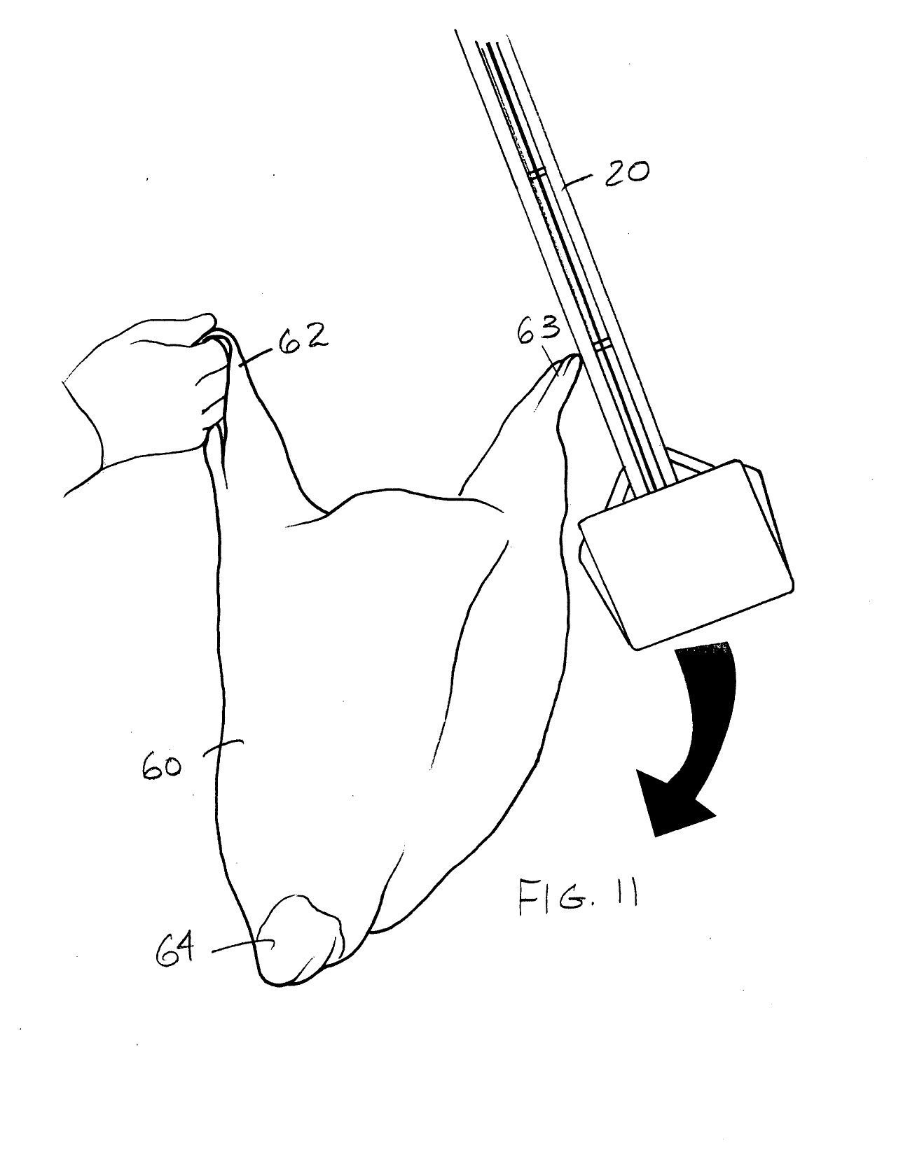

Referring to FIG. 11, subsequent opening of jaws 34 and 35 by pulling on handle 40 will allow the refuse 64 to fall out of jaws 34 and 35. However, the refuse remains within the inside-out interior of bag 60. Bag 60 can then be deposited in a trash receptacle.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for retrieving refuse, comprising:
providing a pair of articulating jaws at one end of a stalk, a hook along the length of the stalk, and a bag having a least one handle;
attaching the bag to the hook by the handle of the bag;
articulating the jaws to an open position;
picking up refuse by the jaws;
closing the jaws after said picking up;
moving the opening of the bag after said closing such that the distal portion of the jaws are inside the bag; and
articulating the jaws to the open position after said moving so that the refuse is dropped into the bag.

2. The method of claim 1 wherein said articulating the jaws to an open position is by one hand of a person, and said moving is by the other hand of the person.

3. A method for retrieving refuse, comprising:
providing a pair of articulating jaws at one end of a stalk, a hook along the length of the stalk, and a flexible bag having a least one handle;
attaching the bag to the hook by the handle of the bag;
placing the bag such that the jaws are inside the bag;
articulating the jaws to an open position after said placing;
picking up refuse and a portion of the bag into the jaws;
closing the jaws after said picking up;
turning the bag inside out after said closing; and
articulating the jaws to the open position after said turning so that the refuse is dropped into the bag.

4. The method of claim 3 wherein said bag has a pair of handles and said attaching is by both handles of the bag.

5. The method of claim 3 wherein said attaching is before said placing.

6. The method of claim 3 wherein said articulating the jaws to an open position is by one hand of a person, and said turning is by the other hand of the person.

7. An apparatus for picking up refuse from the ground, comprising:
a stalk having two ends;
a handle at one end of said stalk;
a pair of articulating jaws at the other end of said stalk; and
a hook mounted to said stalk at a location between said handle and said jaws.

8. The apparatus of claim 7 wherein the opening of said hook is oriented toward said handle.

9. The apparatus of claim 8 wherein said the opening of said hook is more than about nine inches from the distal portion of said jaws and less than about thirteen inches from the distal portion of said jaws.

10. The apparatus of claim 8 wherein said the opening of said hook is more than about ten inches from the distal portion of said jaws and less than about twelve inches from the distal portion of said jaws.

11. The apparatus of claim 7 wherein said handle is a static handle mounted to said stalk and which further comprises a second, movable handle located proximate to said static handle, wherein said jaws articulate in response to movement of said second handle.

12. The apparatus of claim 11 wherein said jaws articulate between a first position and a second position, and which further comprises a spring for biasing said jaws to one of said first position or said second position.

13. The apparatus of claim 7 wherein said hook includes a plurality of serrations.

14. The apparatus of claim 7 which further comprises a flexible bag, said bag having a pair of walls on opposing sides of an opening, each said wall defining a hole that is a predetermined distance from the bottom of said bag.

15. The apparatus of claim 14 wherein said bag is a T-shirt or punch handle bag.

16. The apparatus of claim 14 wherein said hook is mounted to said stalk at a location such that the bottom of said bag extends below the distal portion of said jaws when a wall of said bag is attached at the hole to said hook.

17. The apparatus of claim 7 which further comprises means for articulating said jaws located proximate to said handle.
